(19) United States
(12) Patent Application Publication
(10) Pub. No.: US 2025/0348471 A1
(43) Pub. Date: Nov. 13, 2025

(54) MACHINE LEARNING-DRIVEN DATA INTEGRATION FOR DATA SPACES AND DIGITAL TWINS

(71) Applicant: NEC Laboratories Europe GmbH, Heidelberg (DE)

(72) Inventors: Flavio Cirillo, Heidelberg (DE); Gurkan Solmaz, Heidelberg (DE)

(21) Appl. No.: 18/791,491

(22) Filed: Aug. 1, 2024

Related U.S. Application Data
(60) Provisional application No. 63/643,509, filed on May 7, 2024.

(51) Int. Cl. G06F 16/215; G06F 16/36

(52) U.S. Cl. CPC G06F 16/215; G06F 16/367

(57) ABSTRACT

A computer-implemented method for homogenizing datasets that have different ontologies to optimize performance of machine learning models that use the datasets includes mapping concepts between the different ontologies of the datasets based on ontology matching. The concepts are scored based on a relation between the concepts to identify certain ones of the concepts that are more important to improving the performance of the machine learning models. The different ontologies are merged based on the scoring to generate a merged ontology that includes the identified concepts. The datasets are transformed into a homogenized dataset according to the merged ontology. A machine learning model is generated based on the homogenized dataset. The method has applications including, but not limited to, use cases in computational biology, medical AI and healthcare, cyberthreat security, public safety and smart cities for optimizing machine learning processes or supporting decision making.

### CROSS-REFERENCE TO PRIOR APPLICATION

Priority is claimed to U.S. Provisional Application Ser. No. 63/643,509 filed on May 7, 2024, the entire contents of which is hereby incorporated by reference herein.

### FIELD

The present disclosure relates to Artificial Intelligence (AI) and machine learning (ML), and in particular to a method, system, data structure, computer program product and computer-readable medium for data integration having applications to data spaces and digital twins.

### SUMMARY

In an embodiment, the present disclosure provides a computer-implemented method for homogenizing datasets that have different ontologies to optimize performance of machine learning models that use the datasets. Concepts between the different ontologies of the datasets are mapped based on ontology matching. The concepts are scored based on a relation between the concepts to identify certain ones of the concepts that are more important to improving the performance of the machine learning models. The different ontologies are merged based on the scoring to generate a merged ontology that includes the identified concepts. The datasets are transformed into a homogenized dataset according to the merged ontology. A machine learning model is generated based on the homogenized dataset. The method has applications including, but not limited to, use cases in computational biology, medical AI and healthcare, and cyber threat security, public safety and smart cities for optimizing machine learning processes or supporting decision making.

### BRIEF DESCRIPTION OF THE DRAWINGS

Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 schematically illustrates data integration for a data space according to exiting technology that is only partly automated and requires human involvement;

FIG. 2 schematically illustrates the building of a backbone ontology for automatic data integration;

FIG. 3 schematically illustrates a digital twin analytics model;

FIG. 4 schematically illustrates a method and system for ML-driven data integration for data spaces and digital twins according to an embodiment of the present disclosure;

FIG. 5 schematically illustrates a concepts scoring module based on a relation according to an embodiment of the present disclosure;

FIG. 6 schematically illustrates a ML-driven ontology merger component according to an embodiment of the present disclosure;

FIG. 7 schematically illustrates a ML-driven ontology merger with redundant concepts for multiple purposes according to an embodiment of the present disclosure;

FIG. 8 schematically illustrates a high-fidelity digital twin creation through ML-driven data integration according to an embodiment of the present disclosure;

FIG. 9 schematically illustrates an HVAC controller that commands schedule based on a predicted temperature of the future;

FIG. 10 schematically illustrates an HVAC controller that commands schedule based on occupancy prediction;

FIG. 11 schematically illustrates a landmine clearance operation based on estimated/predicted hazard risks; and

FIG. 12 is a block diagram of an exemplary processing system, which can be configured to perform any and all operations disclosed herein.

### DETAILED DESCRIPTION

Embodiments of the present disclosure provide a framework to automatically homogenize datasets in order to optimize the performance of machine learning models that use the datasets. The homogenized data model is built from multiple datasets by scoring the models that perform better in AI prediction tasks.

In a first aspect, the present disclosure provides a computer-implemented method for homogenizing datasets that have different ontologies to optimize performance of machine learning models that use the datasets. Concepts between the different ontologies of the datasets are mapped based on ontology matching. The concepts are scored based on a relation between the concepts to identify certain ones of the concepts that are more important to improving the performance of the machine learning models. The different ontologies are merged based on the scoring to generate a merged ontology that includes the identified concepts. The datasets are transformed into a homogenized dataset according to the merged ontology. A machine learning model is generated based on the homogenized dataset.

In a second aspect, the present disclosure provides the method according to the first aspect, further comprising generating data transformer functions based on a template, wherein transforming the datasets into the homogenized dataset is based on the data transformer functions, the data transformer functions filtering certain data from the datasets.

In a third aspect, the present disclose provides the method according to the first aspect or the second aspect, wherein the datasets are obtained from one or more entities associated with a building system, wherein the machine learning model is configured to predict an action of a component of the building system, the computer-implemented method further comprising generating the action of the component based on the machine learning model and certain data for the building system.

In a fourth aspect, the present disclosure provides the method according to any of the first to third aspects, wherein the component of the building system is part of a heating, ventilation, and air conditioned controller (HVAC) system, and wherein the action includes operating the component of the HVAC system.

In a fifth aspect, the present disclosure provides the method according to any of the first to fourth aspects, wherein generating the data transformer functions is further based on a repository of functions, a large language model (LLM) system that generates code, or a machine learning based transformer trained on a sequence of source data to target data.

In a sixth aspect, the present disclosure provides the method according to any of the first to fifth aspects, wherein scoring the concepts based on the relation between the concepts includes calculating a Pearson correlation between each pair of concepts of the concepts, wherein a pair of concepts includes pairs among different primary ontologies of the different ontologies, and pairs within a same primary ontology of the different ontologies, and wherein scores of the concepts represent a strength of a linear relationship between two given concepts of the pair of concepts.

In a seventh aspect, the present disclosure provides the method according to any of the first to sixth aspects, wherein scoring the concepts based on the relation between the concepts is based on a machine learning routine that builds a machine learning model for each concept of a primary ontology for each dataset of the datasets, wherein each machine learning model generates a feature importance array that is used for scoring the concepts.

In an eighth aspect, the present disclosure provides the method according to any of the first to seventh aspects, wherein scoring the concepts based on the relation between the concepts includes using a large language model (LLM) system that uses as input the datasets and knowledge, wherein the LLM system and prompt engineering generate a score for each pair of concepts of the concepts.

In a ninth aspect, the present disclosure provides the method according to any of the first to eighth aspects, wherein generating the merged ontology includes implementing a merger system that uses as input primary ontologies of the datasets and the scored concepts.

In a tenth aspect, the present disclosure provides the method according to any of the first to ninth aspects, wherein the merger system generates notes of equality between the concepts in the merged ontology, wherein generating the data transformer functions is further based on the notes of equality.

In an eleventh aspect, the present disclosure provides the method according to any of the first to tenth aspects, further comprising: receiving data including weather information, seasonality information, and current occupancy information for a building; generating an indoor temperature prediction for the building based on the machine learning model using the weather information, seasonality information, and the current occupancy information; and generating instructions for actuating a heating, ventilation, and air conditioned controller (HVAC) system of the building in accordance with the indoor temperature prediction.

In a twelfth aspect, the present disclosure provides the method according to any of the first to eleventh aspects, further comprising: receiving data including weather information and seasonality information for a building; generating a building occupancy prediction for the building based on the machine learning model using the weather information and the seasonality information; and generating instructions for actuating a heating, ventilation, and air conditioned controller (HVAC) system of the building in accordance with the building occupancy prediction.

In a thirteenth aspect, the present disclosure provides the method according to any of the first to twelfth aspects, further comprising: receiving data including coordinates for an area, vegetation density for the area, and facilities in the area; generating a hazard risk prediction for the area based on the machine learning model using the coordinates, the vegetation density, and the facilities; and generating priorities assigned to certain sub-areas of the area using the hazard risk prediction, wherein the priorities represent a precedence in clearance planning for the area.

In a fourteenth aspect, the present disclosure provides a computer system for homogenizing datasets that have different ontologies to optimize performance of machine learning models that use the datasets comprising one or more processors, which, alone or in combination, are configured to perform a machine learning method for homogenizing datasets that have different ontologies to optimize performance of machine learning models that use the datasets using a machine learning process according to any of the first to thirteenth aspects.

In a fifteenth aspect, the present disclosure provides a tangible, non-transitory computer-readable medium for homogenizing datasets that have different ontologies to optimize performance of machine learning models that use the datasets using a machine learning process which, upon being executed by one or more hardware processors, provide for execution of a machine learning method according to any of the first to thirteenth aspects.

Data spaces represent an evolutionary advancement in data integration architectures where different data sources and providers share their data for mutual benefits. Anticipated to emerge as a central focus and tool within the future data economy, data spaces aim to address the escalating demand for aggregating data originating from disparate domains, industries, and legal jurisdictions.

A first approach to build a data space is to agree on a standardized data model with an agreed ontology. There exists many standards, data models and ontologies, however the interoperability issue is still an open technical challenge since diverse stakeholders might adopt different standards (or even different variants of the same standard) for different purposes.

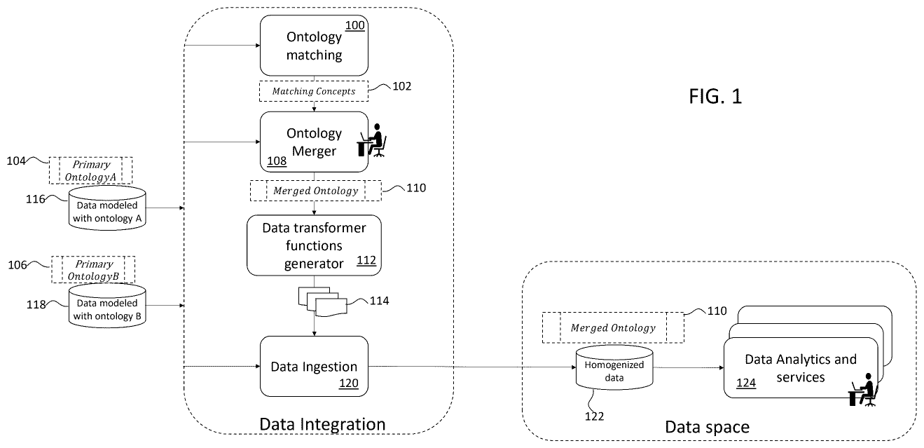

To reduce the integration costs and speed up the interoperability, automatic or semi-automatic methods aim to build a common ontology that serves as a common data representation for all the involved datasets from the involved parties. FIG. 1 shows a general method for this integration. First, an ontology matching component (ontology matcher) 100 identifies the semantic matching of concepts 102 from different ontologies 104 and 106. The matching might happen by using different approaches such as analyzing textual concept descriptions within primary ontologies (e.g., Resource Description Framework (RDF) files) using Natural Language Processing systems, by analyzing the data instances (e.g., column matching in relational databases), or by a combination of the two methods. For example, a deep learning model based on natural language processing techniques to obtain semantic mappings between source and target schemas using only an attribute name and description may be used as described in Zhang, Jing, et al. “SMAT: An attention-based deep learning solution to the automation of schema matching.” Advances in Databases and Information Systems: 25th European Conference, ADBIS 2021, Tartu, Estonia, Aug. 24-26, 2021, Proceedings 25. Springer International Publishing, 2021, which is hereby incorporated by reference. As another example, column matching in relational databases may be achieved by using a two-step technique that works by measuring pair-wise attribute correlations in tables to be matched and constructing a dependency graph using mutual information as a measure of the dependency between attributes. Matching node pairs in the dependency graphs may be found by running a graph matching algorithm as described by Kang, Jaewoo, and Jeffrey F. Naughton. “On schema matching with opaque column names and data values.” Proceedings of the 2003 ACM SIGMOD international conference on Management of data. 2003, which is hereby incorporated by reference. Other approaches such as that described in Hättasch, B., et al. “It's AI Match: A Two-Step Approach for Schema Matching Using Embeddings. arXiv 2022.” arXiv preprint arXiv: 2203.04366, which is hereby incorporated by reference, may also be utilized. The results of this operation is a mapping of concepts between the two ontologies 104 and 106. Sometimes, the mapping might happen also within the same ontology (e.g., for repeated concept to support new and legacy systems).

The ontology merger component (ontology merger) 108 compiles a merged ontology 110 that covers all the concepts from the primary ontologies 106 and 106. There might multiple criteria on how to execute this step. A first approach is to let a human decide upon the concepts to retain. Another approach is to give priority to concepts of one of the ontologies (called a backbone ontology) and integrate to it only new concepts from the other primary ontologies. Other approaches could be to prioritize a target application or service, in which case the merged ontology 110 must be coherent with the target application or service. Once the backbone ontology is formed and the primary ontologies 104 and 106 are mapped to it, the data transformer function generator module (data transformer function generator) 112 generates transformation functions 114 to integrate data of the primary datasets 116 and 118 into the merged data model. This component 112 might be fully automatic (e.g., based on code template or AI techniques) or it can guide a human to implement the mapping functions. The data ingestion component (data ingester) 120 uses the data transformer functions 114 to generate the homogenized dataset 122. This dataset 122 includes data from the initial datasets 116 and 118 but the data is modeled with the common merged ontology 110. This data can be used for data analytics and services 124.

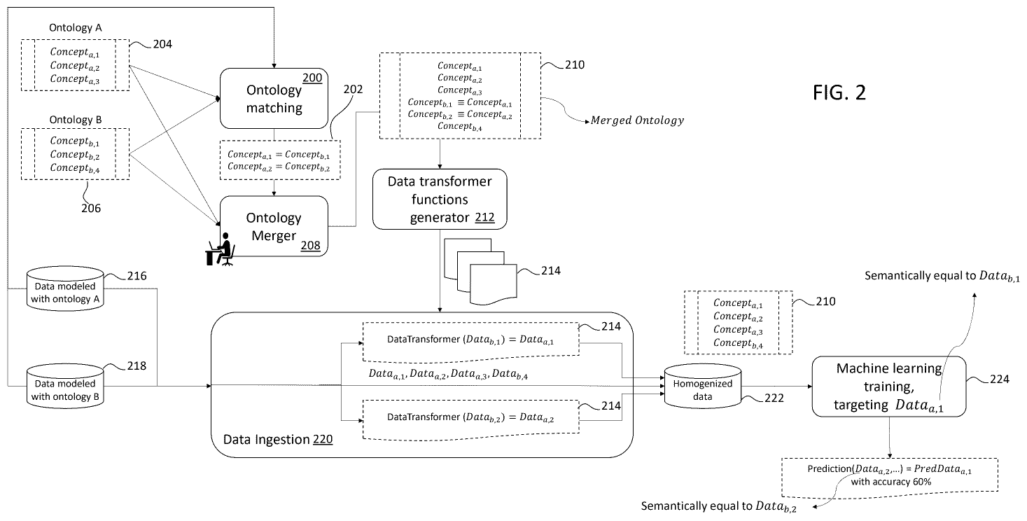

FIG. 2 shows an example of the data merging targeting a machine learning model as an application that uses the homogenized data. In particular, the data analytics task is to predict one of the backbone ontology concepts. This approach has the advantage that there is a bigger dataset for generation of analytics, thereby resulting in better services. However, a machine learning model would need human effort to achieve good performances. This human effort includes feature extraction and feature engineering. Therefore, once the data is homogenized, a data scientist needs to take the data and preprocess it. A good example is how to treat timestamp, e.g., as a date, as hour and minutes, as time of the day in the range [0,1], etc. Therefore, although the data is homogenized, it is still not possible to have automatic machine learning model generation.

A digital twin is a virtual representation of a real-world object, system, or process. Harnessing the diverse data sources and data providers in the data spaces involves the capacity to construct and oversee expansive, high-fidelity digital twins on a large scale. For instance, a digital twin of a smart district (e.g., a section of urban area) might require data from multiple stakeholders such as energy providers, network providers, building management, and public transportation. This data enables the digital twin to simulate and mimic the behavior, performance, and characteristics of the real-world object or system. This data analytics and services (see FIG. 2) can provide insights, analysis, and predictions, helping to optimize operations, troubleshoot issues, and make informed decisions without needing to directly interact with the physical object. In the scenario of FIG. 2, a digital twin should be able to infer Data_{a,1} based on the other data fields available. If the data is not in a format best suited for that task, the twinning of that characteristic will have low-fidelity in the digital world. A data scientist should spend effort for that specific task to achieve a high-fidelity twin. A data scientist would need to spend effort for every characteristic, thereby making the scalability of the digital twin creation a challenge.

FIG. 2 includes an ontology matching component 200 that identifies matching concepts 202 from different ontologies 204 and 206. The result of this operation is a mapping of concepts 202 between the two ontologies 204 and 206. An ontology merger component 208 may compile a merged ontology 210 that covers all the concepts from the ontologies 204 and 206. In FIG. 2 the data transformer functions generator 212 generates transformation functions 214 to integrate data of datasets 216 and 218 into a merged data model. The data ingestion component 220 uses the data transformer functions 214 to generate the homogenized dataset 222. The homogenized dataset 222 includes data from the datasets 216 and 218 but the data is modeled with the merged ontology 210. As depicted in FIG. 2, the homogenized data 222 can be used in machine learning training 224 such that a digital twin should be able to infer Data_{a,1} based on the other data fields available.

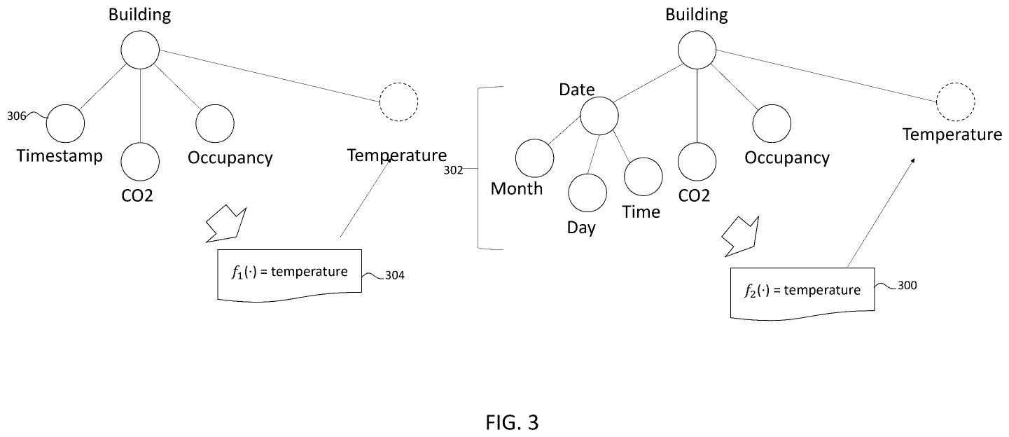

The digital twin approach can be used for the management of buildings aiming at reducing the energy consumption. Modeling and predicting building behavior, such as indoor temperature or occupancy, a smart service might be able to reduce energy expenditure. The generation of the function based on machine learning functions for each of the characteristics of the digital twin model would be very costly in terms of resources if made by a human. For example, a function to predict temperature would have different accuracy depending on the different data model. In FIG. 3, the accuracy of f₂(⋅) 300 will certainly have better performance since it will use explicit seasonality information (i.e., month of the year) 302, while f₁(⋅) 304 uses only the timestamp 306.

OLaLa (see Hertling, Sven, and Heiko Paulheim, “OLaLa: Ontology matching with large language models,” Proceedings of the 12th Knowledge Capture Conference (2023), which is hereby incorporated by reference herein) is a prototype that leverages Large Language Models (LLMs) to achieve ontology matching with zero-shots and few-shots prompting. The approach is mainly to identify which concepts match with each other. However, the solution of OLaLa is not considering the actual data for matching the concepts, but only the concept name and description, thus, they are not optimizing the machine learning performance of data processing built on the matched ontologies.

Ochieng, Peter, and Swaib Kyanda, “Large-scale ontology matching: State-of-the-art analysis,” ACM Computing Surveys (CSUR) 51.4, 1-35 (2018), which is hereby incorporated by reference herein, present a survey on ontology matching describing different techniques for ontology matching and considering different approach. One technique for the ontology matching is the exploitation of the ontology's structural relationship. This refers to the relationships between concepts as defined in the ontology to reduce the search space for the matching. This differs from the concept of scoring as used in embodiments of the present disclosure since concept scoring takes into consideration the actual instance of the concepts to understand those best suitable for the improving machine learning performance.

Recent advancement of LLMs have led the way to various opportunities in technical advancements such as data integration. Sharma, Ankita, et al., “Automatic data transformation using large language model—an experimental study on building energy data,” IEEE International Conference on Big Data (2023), which is hereby incorporated by reference herein, show a pipeline to automatically integrate data from a source dataset to a target schema and generate data consuming processes. This prototype is conceptually similar to the one shown in FIG. 1. Nevertheless, Sharma et al. assume that the target schema is given without further consideration. Therefore, Sharma et al. rely on external knowledge (such as a human) to identify the best schema for best machine learning performance. In contrast, embodiments of the present disclosure use concept scoring to evaluate the best schema to be used and a machine learning model with good performance automatically.

While data spaces enable the sharing of data between multiple stakeholders, and thereby increase the quality of data analytics processes, the performance of data analytics services still depend on human data scientists to process the homogenized data for a specific purpose (or task). This approach poses a scalability challenge to the technical task of automatic digital twin generation.

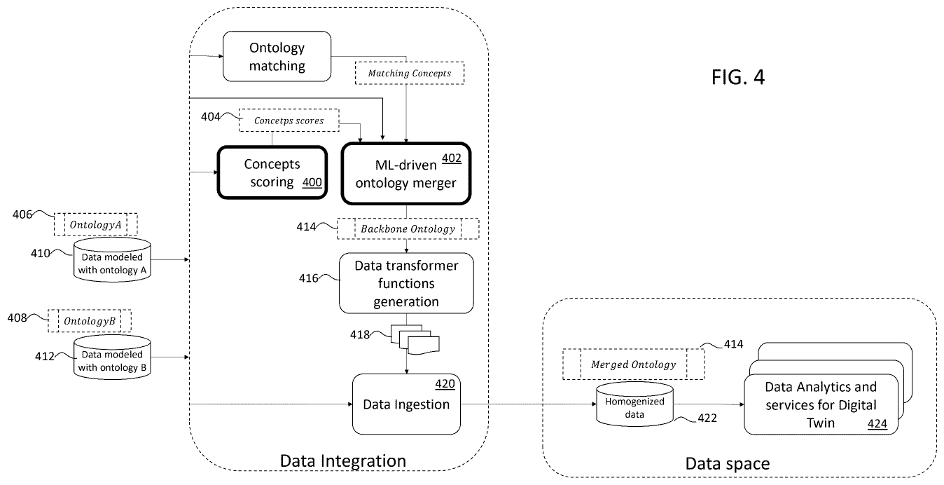

Embodiments of the present disclosure aim at generating the merged ontology targeting the best performance in machine learning services. In the state of the art, an ontology is made by a human for humans. In contrast, embodiments of the present disclosure provide an ontology generated by a machine for machines. An overview of the system according to an embodiment is depicted in FIG. 4. The new method includes two new modules that are the concepts scoring module (concepts scorer) 400 and the ML-driven ontology merger (ontology merger) 402. These two components enable the automatic generation of digital twins.

### Concepts Scoring:

The concepts scoring module 400 generates a score per concept (concept scores 404) to steer the choice of which concepts to include in the merged ontology. This module 400 takes as input the primary ontologies 406 and 408, the dataset modeled 410 and 412 with the primary ontologies 406 and 408, and it generates scores 404. Different embodiments of the present disclosure can implement the concepts scoring module 400 in different ways. The ML-driven ontology merger component 402 takes as input the primary ontologies 406 and 408 and the concept scores 404 to generate a merged ontology (backbone ontology) 414. In FIG. 4, the data transformer functions generator (data transformer functions generation) 416 generates transformation functions 418 to integrate data (data ingestion 420) of datasets 410 and 412 into a merged data model (homogenized data) 422. In embodiments, the homogenized dataset 422 may be used for data analytics and services for digital twin predictions or simulations 424.

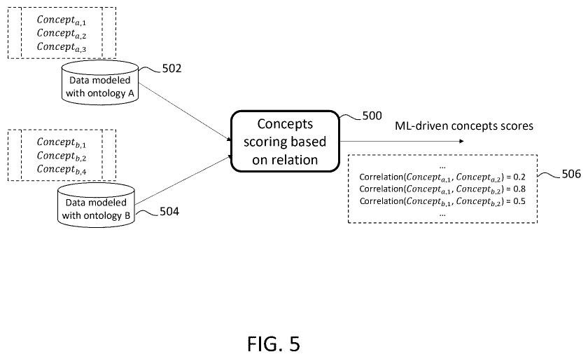

The embodiment of FIG. 5 shows the concepts scoring module 500 based on a relation. In this particular embodiment, the module 500 takes as input the datasets 502 and 504 and calculates the Pearson correlation between each pair of concepts of the datasets 502 and 504. The concepts pairs include: i) pairs among different primary ontologies, and ii) pairs within the same primary ontology. Each score 506, in this case, represents the strength of the linear relationship between two concepts that measure how easily it is possible to generate the signal of the first concept knowing the second concept, and vice versa (e.g. referring to the degree to which a pair of variables are linearly related). In this sense, choosing concepts that present higher correlation with other concepts is more beneficial for the data analytics. The final output can be represented in a matrix. The computed matrix is used by the ML-driven Ontology Merger to choose the concepts that are more beneficial for the data analytics.

In other embodiments, the concepts scoring module 500 might be based on AutoML. In this case, the concepts scoring module 500 runs a routine that uses AutoML to build a machine learning model for each of the concepts of the primary ontology using all the available datasets 502 and 504. The routine runs in a loop: for each concept of the primary ontology a ML model is trained through AutoML to predict such a concept using all the other concepts. For each generated machine learning model, the concepts scoring module 500 produces a feature importance array (not pictured). All of those arrays are used as scores 506. Also in this case the output can be represented in a matrix.

In yet another embodiment, an LLM-based system could be used to yield a score for each pair. By prompt engineering, this embodiment might provide to the LLM prompt data examples and metadata (e.g., names and description) of two concepts and request a score.

### ML-Driven Ontology Merger:

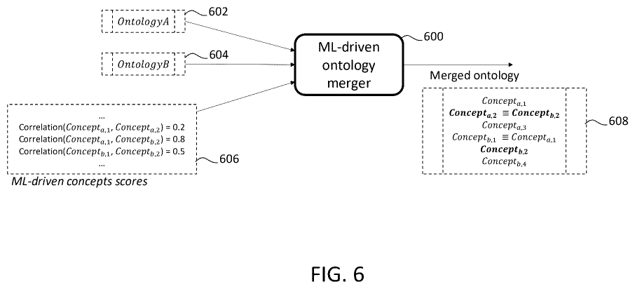

The ML-driven ontology merger component 600 of FIG. 6 takes as input the primary ontologies 602 and 604 and the scores 606 from the concepts scoring module and compiles a merged ontology 608.

The ML-driven ontology merger component 600 prioritizes the selection of the concepts depending on the ML-driven scores 606. Taking into account the example in FIG. 6, the ML-driven ontology merger component 600 would choose Concept_{b,2} instead of Concept_{a,2} as part of the merged ontology 608 and, then, note the equality between the two concepts.

In some cases, the concepts scoring module, such as 500, might give different scores for the same concept. For instance, in the case of correlation-based scoring, the same concept might have a high correlation for a pair and a low correlation for another pair. The ML-driven ontology merger component 600 might adopt different policies to aggregate the scoring. One aggregation policy might be averaging, where each concept is assigned the average of all the scores of pairs that include such a concept. Another aggregation policy might be maximum, where each concept is assigned the maximum of all the scores of pairs that include such a concept.

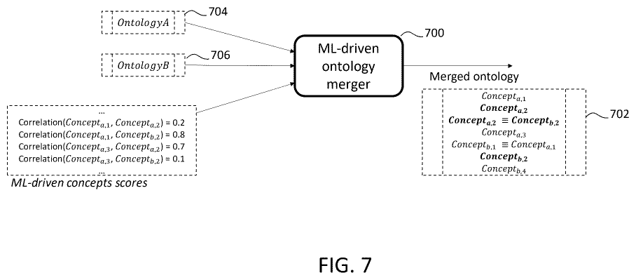

It might even be possible that two equal concepts (such as Concept_{a,2} and Concept_{b,2} in FIG. 7) have ambiguous scoring depending on the concept under investigation. In this case, in one embodiment, the ML-driven ontology merger component 700 decides to keep both the concepts in the merged ontology 702 together with the equality noted. In this way, the automatic generation of a machine learning model might require to apply automatic techniques of feature selection, but it would be still capable to generate the machine learning model. By keeping both the concepts in the merged ontology 702 the system provides redundancy in the data. The feature selection may choose between the most importance concept among the two equivalent concepts. The notes of equality between concepts among primary ontologies 704 and 706 are used by the data transformer functions generator to identify which functions to generate.

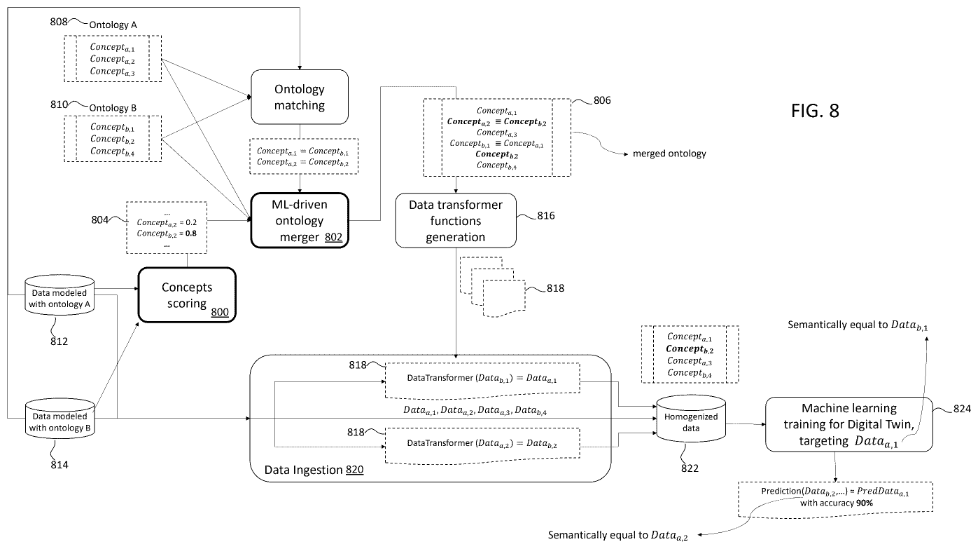

FIG. 8 shows a full example with the generation of a high-fidelity digital twin through the ML-driven data integration according to an embodiment of the present disclosure. The example of FIG. 8 includes a concept scoring component (concepts scoring) 800 and an ML-driven ontology merger component (ML-driven ontology merger) 802 that enable automatic generation of digital twins. The concepts scoring component 800 generates a score per concept (concept scores 804) to steer the choice of which concepts to include in the merged ontology 806. This module 800 takes as input primary ontologies 808 and 810, represented in FIG. 8 as “Ontology A” and “Ontology B”, the dataset modeled 812 and 814 with the primary ontologies 808 and 810, and it generates scores 804.

The ML-driven ontology merger component 802 of FIG. 8 takes as input the primary ontologies 808 and 810 and the concept scores 804 to generate a merged ontology 806. In FIG. 8, the data transformer functions generator (data transformer functions generation) 816 generates transformation functions 818 to integrate data (data ingestion 820) of datasets 812 and 814 into a merged data model (homogenized data) 822. As depicted in FIG. 8, the homogenized data 822 can be used in machine learning training 824 such that a digital twin should be able to infer Data_{a,1} based on the other data fields available.

### Data Transformer Function Generations:

Once the merged ontology and the concept mapping are ready, it is possible to generate functions for the data transformation between equivalent concepts. This generation can be done with different techniques. In one embodiment, a repository of functions can be used or adapted (e.g., starting from a template) for the scope. In this case, a template might contain a function that uses available translation libraries to be tuned as needed. For example, a function that use a library to translate from OpenStreetMap elements (e.g., OpenStreetMap open and closed way) to a geometry shape (e.g., polygon), might be tuned to select the correct routine of the library depending on the source data and target data. In other embodiments, it is possible to make usage of LLM systems to generate code. For example, using prompt engineering example data instance of a first concept and example data instance of an equivalent concept are given to an LLM. The LLM system may then generate a function in the wished programming language.

Embodiments of the present disclosure thus provide for general improvements to computers in machine learning systems to automatically homogenize datasets to improve the performance of machine learning models, and to enable automatic generation of digital twins. Moreover, embodiments of the present disclosure can be practically applied to use cases to effect further improvements in a number of technical fields including, but not limited to, medical (e.g., digital medicine, personalized healthcare, AI-assisted drug or vaccine development, etc.), material development, cyberthreat security, public safety and smart cities (e.g., automated traffic or vehicle control, smart districts, smart buildings, smart industrial plants, smart agriculture, energy management, etc.), or other technical fields that face the technical problem of divergent datasets or that can benefit from the use of digital twins.

One embodiment can be practically applied for energy efficient building management. Buildings are one of the biggest consumer of energy worldwide. Intelligence on controlling their operation advantageously provides to reduce carbon production and improve quality of life of building users. For example, certain operations in the building might schedule differently in order to make usage of renewable source of energy, such as light and heating from the sun, and green energy produced by solar panels or wind turbines. Nevertheless, intelligence requires precise information of the current and future status of the building. The more precise the information, the better the results in the optimizations.

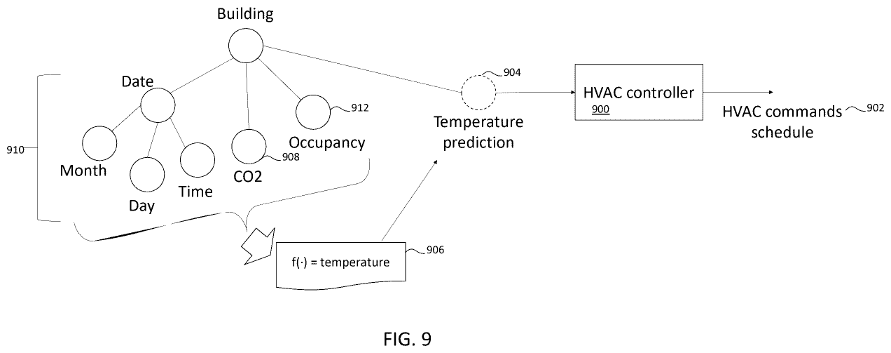

For example, a use case is that a heating, ventilation and air conditioner (HVAC) controller is instructed to maintain the indoor temperature to a comfortable level. FIG. 9 schematically illustrates an HVAC controller 900 that commands schedule 902 based on a predicted temperature of the future 904. However, it might be that there is not a temperature sensor installed in a specific room. A predictor 906 might use weather information 908, seasonality (day of week, month, and hour of the day) 910 and current occupancy information (e.g., extracted from a Wi-Fi access point) 912 to infer current and future indoor temperature 904. The HVAC controller 900 can then operate with minimum energy impact to maintain a comfortable temperature without misusing the system or wasting resources (e.g., overheating or overcooling of the common space). In embodiments, the predictor 906 may be a machine learning model trained on a homogenized dataset that is generated according to the embodiments described herein for predicting or inferring current and future indoor temperature of a building.

An example of data model given can be seen in the following (compiled from smartdatamodels.org and w3.org):

```
{
  “id”: “urn:ngsi-ld: AirQualityObserved:Madrid-AmbientObserved-28079004-2016-03-
15T11:00:00”,
  “type”: “AirQualityObserved”,
  “co”: 500,
  “coLevel”: “moderate”,
  “airQualityIndex”: 65,
  “airQualityLevel”: “moderate”,
  “dateObserved”: “2016-03-15T11:00:00”,
  “location”: {
    “coordinates”: [
      −3.712247222222222,
      40.423852777777775
    ],
    “type”: “Point”
    },
  “precipitation”: 0,
  “relativeHumidity”: 0.54,
  “temperature”: 12.2,
  ]
}
{
  “id”: “urn:ngsi-ld: AirQualityObserved:Madrid-AmbientObserved-28079004-2016-03-
15T11:00:00”,
  “type”: “AirQualityObserved”,
  “co”: 500,
  “coLevel”: “moderate”,
  “airQualityIndex”: 65,
  “airQualityLevel”: “moderate”,
  “date”: {
    “year”: “2016”,
    “month”: “03”,
    “day”: “15”,
    “dayOfWeek”: “Tuesday”,
    “hour”: “11”,
    “minute”: “00”,
    “second”: “00”,
  },
  “location”: {
    “coordinates”: [
      −3.712247222222222,
      40.423852777777775
    ],
    “type”: “Point”
  },
  “precipitation”: 0,
  “relativeHumidity”: 0.54,
  “temperature”: 12.2,
  ]
}
```

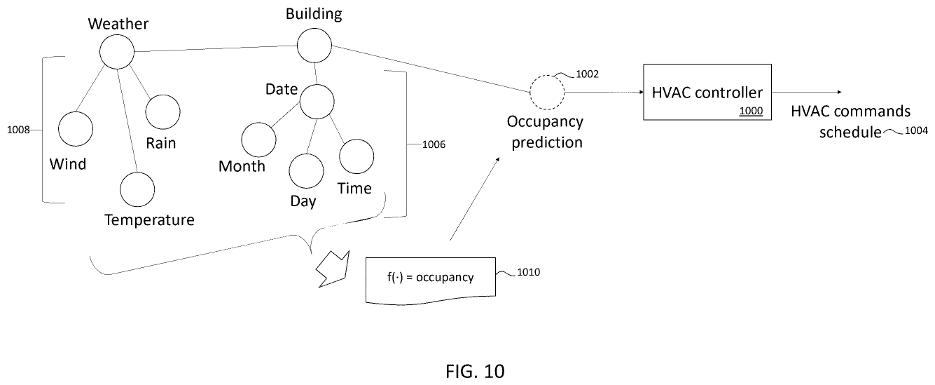

In another embodiment as depicted in FIG. 10, the HVAC controller 1000 can use the prediction of the occupancy 1002 for a whole day to plan HVAC control (HVAC commands schedule) 1004 for the coming day. The concepts scoring module of embodiments of the present disclosure can learn from a dataset that information for working hours only (09:00 to 20:00), represented by data, month, day, time 1006, are more useful to train a more accurate prediction model for occupancy than weather information 1008. For example, this could be learned by an AutoML routine on two different datasets (e.g., “Integral Data” and “Working Hours” classes) resulting in the results of Table 1. In this case, the ontology merger will decide to select “Working Hours” class data. The transformer functions generator generates a function that filters out night data between 20:00 and 09:00.

In some application, it might happen that the whole dataset (i.e., also the night data) can be useful for other prediction tasks (such as temperature prediction). In this case, the ML-driven ontology merger component will select both the “Integral Data” class and “Working Hours” class stating the equivalence of them.

TABLE 1
Coefficient of determination for occupancy prediction applied
on full dataset and dataset limited to working hours only.

| | | Linear Regression |
|---|---|---|
| | Linear Regression | on “Working |
| | on “Integral | Hours” class data |
| | Data” class | (opening time 09:00-20:00) |
| Coefficient of | −0.11 | 0.20 |
| determination for | | |
| occupancy prediction | | |

The machine learning model trained using the integrated data according to an embodiment of the present disclosure can be used for smart building predictions, such as temperature or occupancy, and can operate building components, such as the HVAC system or sensors, in an automated manner based on the model outputs. For example, referring to FIG. 10, the machine learning model can represent predictor 1010 might use weather information 1008, seasonality (day of week, month, and hour of the day) 1006 to infer current and future occupancy 1002 for the building. The HVAC controller 1000 may control operate building components based on the occupancy prediction 1002 such as changing a temperature for certain rooms of a building to save energy.

Another embodiment can be practically applied for public safety, in particular, humanitarian hazard risk assessment (e.g., landmine risks) and respective operations such as landmine clearance operations, disaster recovery, and socioeconomic development. Planning based on correct hazard risk assessment improves the efficiency in terms of time and limited resource usage during the humanitarian operations.

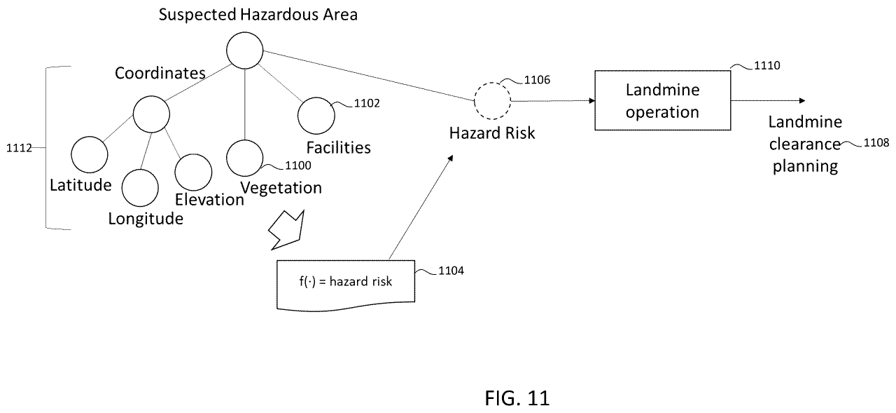

Many humanitarian data sources openly or proprietarily that are available follow different ontologies, schemas, or standards such as IMSMA core schema and empathi ontology. Embodiments of the present disclosure enable to bring together the best data structures which would improve the machine learning performance for hazard risk estimation/prediction. In this case, the ontology merger will decide to select the relevant data and the transformer functions generator generates a function that filters out certain data. For instance, in the example shown in FIG. 11, the ontology merger choses “Vegetation” 1100 (daily/monthly time-series data) and certain facility data (e.g., key facilities such as road infrastructure) 1102 and filters out coordinates data 1112. The transformer functions generator generates a function that filters out irrelevant data such as data from past-conflict times (e.g., outdated data).

The resulting outcome of machine learning prediction 1104 are hazard risk assessments 1106, such as the landmine risk probabilities. These values are used for hazard landmine clearance operation planning 1108 for a landmine operation 1110 such that the areas with higher probabilities are given precedence or priority. Thus, the outcome of the use of the ontology merger and transformer will result in more efficient humanitarian operation with reduced time and resource usage.

The machine learning model trained using the integrated data according to an embodiment of the present disclosure can be used for automated safety actions, such as operating sensors, safety equipment (e.g., drones or explosive-detection robots), traffic control equipment (such as lights or barriers) or area-monitoring equipment (such as cameras).

In an embodiment, the present disclosure provide a method for automatic data integration for digital twin analytics, the method comprising the steps of:
1) Receiving input of raw datasets of smart spaces of buildings from different stakeholders and their ontologies/data models.
2) Matching ontologies resulting in mapping equal concepts between ontologies.
3) Scoring concepts based on the importance of the concepts for building machine learning models.
4) Merging the ontologies by choosing the best concepts based on the scoring of step 3 to be included in the merged ontology.
5) Transforming the original datasets into a homogenized dataset that follows the merged ML-driven ontology.
6) Automatically generating an accurate machine learning model to represent the digital twin behavior (e.g., of corresponding buildings or other object or system being modeled) and prescribe actions for its optimal operation.
7) Actuating the prescribed actions by the real world system or object (e.g., building systems such as HVAC, light control, water supply, etc.).

Embodiments of the present disclosure provide for the following improvements and technical advantages over existing technology:
1. Providing to score the concepts of the primary ontologies to identify the concepts that perform better in machine learning models, thereby enabling to build machine learning models having enhanced performance in terms of accuracy and saving computational resources and power.
2. Providing to compile the merged ontology including unique concepts among primary ontologies and select the concepts with higher scores in case of matching concepts between primary ontologies. The merged ontology will form the data model ready for automatic accurate machine learning model creation.
3. Enabling the automatic generation of digital twins without requiring human effort or intervention.
4. Providing that the machine learning model generated using the dataset homogenized with the approach of embodiments of the present disclosure will have better performance compared with other data integration techniques, especially reducing the data pre-processing burden.

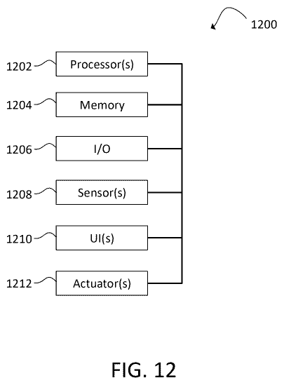

Referring to FIG. 12, a processing system 1200 can include one or more processors 1202, memory 1204, one or more input/output devices 1206, one or more sensors 1208, one or more user interfaces 1210, and one or more actuators 1212. Processing system 1200 can be representative of each computing system disclosed herein.

Processors 1202 can include one or more distinct processors, each having one or more cores. Each of the distinct processors can have the same or different structure. Processors 1202 can include one or more central processing units (CPUs), one or more graphics processing units (GPUs), circuitry (e.g., application specific integrated circuits (ASICs)), digital signal processors (DSPs), and the like. Processors 1202 can be mounted to a common substrate or to multiple different substrates.

Processors 1202 are configured to perform a certain function, method, or operation (e.g., are configured to provide for performance of a function, method, or operation) at least when one of the one or more of the distinct processors is capable of performing operations embodying the function, method, or operation. Processors 1202 can perform operations embodying the function, method, or operation by, for example, executing code (e.g., interpreting scripts) stored on memory 1204 and/or trafficking data through one or more ASICs. Processors 1202, and thus processing system 1200, can be configured to perform, automatically, any and all functions, methods, and operations disclosed herein. Therefore, processing system 1200 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 1200 can be configured to perform task “X”. Processing system 1200 is configured to perform a function, method, or operation at least when processors 1202 are configured to do the same.

Memory 1204 can include volatile memory, non-volatile memory, and any other medium capable of storing data. Each of the volatile memory, non-volatile memory, and any other type of memory can include multiple different memory devices, located at multiple distinct locations and each having a different structure. Memory 1204 can include remotely hosted (e.g., cloud) storage.

Examples of memory 1204 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 1204.

Input-output devices 1206 can include any component for trafficking data such as ports, antennas (i.e., transceivers), printed conductive paths, and the like. Input-output devices 1206 can enable wired communication via USB®, DisplayPort®, HDMI®, Ethernet, and the like. Input-output devices 1206 can enable electronic, optical, magnetic, and holographic, communication with suitable memory 1206. Input-output devices 1206 can enable wireless communication via WiFi®, Bluetooth®, cellular (e.g., LTE®, CDMA®, GSM®, WiMax®, NFC®), GPS, and the like. Input-output devices 1206 can include wired and/or wireless communication pathways.

Sensors 1208 can capture physical measurements of environment and report the same to processors 1202. User interface 1210 can include displays, physical buttons, speakers, microphones, keyboards, and the like. Actuators 1212 can enable processors 1202 to control mechanical forces.

Processing system 1200 can be distributed. For example, some components of processing system 1200 can reside in a remote hosted network service (e.g., a cloud computing environment) while other components of processing system 1200 can reside in a local computing system. Processing system 1200 can have a modular design where certain modules include a plurality of the features/functions shown in FIG. 12. For example, I/O modules can include volatile memory and one or more processors. As another example, individual processor modules can include read-only-memory and/or local caches.

While subject matter of the present disclosure has been illustrated and described in detail in the drawings and foregoing description, such illustration and description are to be considered illustrative or exemplary and not restrictive. Any statement made herein characterizing the invention or disclosure is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer-implemented method for homogenizing datasets that have different ontologies to optimize performance of machine learning models that use the datasets, the computer-implemented method comprising:
mapping concepts between the different ontologies of the datasets based on ontology matching, wherein the datasets each comprise a relational database in a form of a table with rows representing data instances and columns representing the concepts;
scoring the concepts based on a relation between the concepts to identify certain ones of the concepts that are more important to improving the performance of the machine learning models;
merging the different ontologies based on the scoring to generate a merged ontology that merges corresponding ones of the columns and includes the identified concepts;
transforming the datasets into a homogenized dataset according to the merged ontology; and
generating a machine learning model based on the homogenized dataset.

2. The computer-implemented method according to claim 1, further comprising generating data transformer functions based on a template, wherein transforming the datasets into the homogenized dataset is based on the data transformer functions, the data transformer functions filtering certain data from the datasets, wherein the template includes a function that uses translation libraries.

3. The computer-implemented method according to claim 2, wherein the datasets are obtained from one or more entities associated with a building system, wherein the machine learning model is configured to predict an action of a component of the building system, the computer-implemented method further comprising generating the action of the component based on the machine learning model and certain data for the building system.

4. The computer-implemented method according to claim 3, wherein the component of the building system is part of a heating, ventilation, and air conditioned controller (HVAC) system, and wherein the action includes operating the component of the HVAC system.

5. The computer-implemented method according to claim 2, wherein generating the data transformer functions is further based on a repository of functions, a large language model (LLM) system that generates code, or a machine learning based transformer trained on a sequence of source data to target data.

6. The computer-implemented method according to claim 1, wherein scoring the concepts based on the relation between the concepts includes calculating a Pearson correlation between each pair of concepts of the concepts, wherein a pair of concepts includes pairs among different primary ontologies of the different ontologies, and pairs within a same primary ontology of the different ontologies, and wherein scores of the concepts represent a strength of a linear relationship between two given concepts of the pair of concepts.

7. The computer-implemented method according to claim 1, wherein scoring the concepts based on the relation between the concepts is based on a machine learning routine that builds a machine learning model for each concept of a primary ontology for each dataset of the datasets, wherein each machine learning model generates a feature importance array indicating importance of each of the concepts that is used for scoring the concepts.

8. The computer-implemented method according to claim 1, wherein scoring the concepts based on the relation between the concepts includes using a large language model (LLM) system that uses as input the datasets and knowledge, wherein the LLM system and prompt engineering generate a score for each pair of concepts of the concepts.

9. The computer-implemented method according to claim 2, wherein generating the merged ontology includes implementing a merger system that uses as input primary ontologies of the datasets and the scored concepts.

10. The computer-implemented method according to claim 9, wherein the merger system generates notes of equality between the concepts in the merged ontology, wherein generating the data transformer functions is further based on the notes of equality.

11. The computer-implemented method according to claim 1, further comprising:
receiving data including weather information, seasonality information, and current occupancy information for a building;
generating an indoor temperature prediction for the building based on the machine learning model using the weather information, seasonality information, and the current occupancy information; and
generating instructions for actuating a heating, ventilation, and air conditioned controller (HVAC) system of the building in accordance with the indoor temperature prediction.

12. The computer-implemented method according to claim 1, further comprising:
receiving data including weather information and seasonality information for a building;
generating a building occupancy prediction for the building based on the machine learning model using the weather information and the seasonality information; and
generating instructions for actuating a heating, ventilation, and air conditioned controller (HVAC) system of the building in accordance with the building occupancy prediction.

13. The computer-implemented method according to claim 1, further comprising:
receiving data including coordinates for an area, vegetation density for the area, and facilities in the area;
generating a hazard risk prediction for the area based on the machine learning model using the coordinates, the vegetation density, and the facilities; and
generating priorities assigned to certain sub-areas of the area using the hazard risk prediction, wherein the priorities represent a precedence in clearance planning for the area.

14. A computer system for homogenizing datasets that have different ontologies to optimize performance of machine learning models that use the datasets, the computer system comprising one or more hardware processors which, alone or in combination, are configured to provide for execution of the following steps:
mapping concepts between the different ontologies of the datasets based on ontology matching, wherein the datasets each comprise a relational database in a form of a table with rows representing data instances and columns representing the concepts;
scoring the concepts based on a relation between the concepts to identify certain ones of the concepts that are more important to improving the performance of the machine learning models;
merging the different ontologies based on the scoring to generate a merged ontology that merges corresponding ones of the columns and includes the identified concepts;
transforming the datasets into a homogenized dataset according to the merged ontology; and
generating a machine learning model based on the homogenized dataset.

15. A tangible, non-transitory computer-readable medium having instructions thereon which, upon being executed by one or more processors, provide for homogenizing datasets that have different ontologies to optimize performance of machine learning models that use the datasets by execution of the following steps:
mapping concepts between the different ontologies of the datasets based on ontology matching, wherein the datasets each comprise a relational database in a form of a table with rows representing data instances and columns representing the concepts;
scoring the concepts based on a relation between the concepts to identify certain ones of the concepts that are more important to improving the performance of the machine learning models;
merging the different ontologies based on the scoring to generate a merged ontology that includes the identified concepts;
transforming the datasets into a homogenized dataset according to the merged ontology; and
generating a machine learning model based on the homogenized dataset.

16. The computer-implemented method according to claim 1, wherein the ontology matching identifies semantic correspondences between the columns.

17. The computer-implemented method according to claim 1, wherein the ontology matching includes column matching the relational databases by measuring pair-wise attribute correlations in the tables and constructing a dependency graph.

18. The computer-implemented method according to claim 2, wherein generating the data transformer functions includes using a large language model that uses a prompt engineering example data instance of a first concept and an example data instance of an equivalent concept to generate the data transformer functions.

19. The computer-implemented method according to claim 1, wherein the machine learning model represents behavior of a digital twin, the method further comprising inferring, by the digital twin, a missing concept from one of the ontologies based on corresponding ones of the concepts from other ones of the ontologies.

20. The computer-implemented method according to claim 1, wherein the scoring is performed by running a routine that uses AutoML to build a corresponding machine learning model for each of the concepts of a primary ontology of the different ontologies using other ones of the ontologies and to produce a feature importance array in each case as scores, wherein the routine runs in a loop, whereby, for each of the concepts of the primary ontology, the corresponding machine learning model is trained through the AutoML to predict the respective concept using the concepts of the other ones of the ontologies.
